(19) United States
(12) Patent Application Publication
(10) Pub. No.: US 2009/0238709 A1
(43) Pub. Date: Sep. 24, 2009

(54) Magnetic vane ejection for a rotary vane air motor

(75) Inventors: Caleb Youker, St Joseph, MI (US); Christopher J. Jaques, St. Joseph, MI (US)

Correspondence Address: MILLER, MATTHIAS & HULL, ONE NORTH FRANKLIN STREET, SUITE 2350, CHICAGO, IL, 60606, US

(73) Assignee: GAST MANUFACTURING, INC, St. Joseph, MI (US)

(21) Appl. No.: 12/050,498

(22) Filed: Mar. 18, 2008

(51) Int. Cl. F04C 29/00; F04C 2/04; F04B 17/00; B23P 15/00

(52) U.S. Cl. 418/179; 418/259; 417/410.3; 29/888.025

(57) ABSTRACT

A magnetic rotary vane pump is disclosed which includes a rotor disposed within a casing that comprises a cavity having an inlet and an outlet. The rotor includes at least one radial slot and at least one vane carried by the radial slot. The vane includes an inner edge directed towards a central axis of the rotor and an outer edge directed towards the casing. The inner edge of the vane is connected to a first magnet. The slot in the rotor includes an inner wall that abuttingly engages or faces the inner edge of the vane when the vane is fully received within the slot. The inner wall of the slot is connected to a second magnet. The two magnets are arranged so that like pole of the magnets face each other thereby biasing the vane out of the slot and against the inner wall of the casing as the rotor rotates. Accordingly, no spring or pin is required to bias the vane outward against the casing or into recesses or slots disposed in the casing wall. The resulting design may be operated faster than conventional vane pumps and with less lubrication or no lubrication than conventional vane pumps.

### FIELD OF THE DISCLOSURE

This disclosure relates to improved rotary vane pumps and, more specifically, to improved vane pump designs. Still more specifically, a rotary vane pump is disclosed wherein the vanes are biased away from the rotor and towards the inner wall of the casing by two magnets with opposite polarity, one magnet is disposed on an inner edge of the vane and the other disposed in the rotor body. The disclosed magnetic rotary vane pump designs are particularly useful in air motors but may be used in other applications where magnetic rotary vane pumps are employed.

### BACKGROUND OF THE DISCLOSURE

Rotary vane pumps are positive-displacement pumps that consist of vanes mounted to a rotor that rotates inside of a cavity. In some cases, the vanes can vary in length or the outward force applied to the vanes can be varied to maintain good contact with the inside surface of the casing as the rotor of the pump rotates. The most simple vane pump is a circular rotor rotating inside of a larger circular cavity. The axes of the rotor and cavity are offset or are eccentric. The vanes are allowed to slide into and out of the rotor as they sealingly engage the inner surfaces of the cavity, thereby creating vane chambers that perform the compressing work as the rotor rotates.

On the intake side of the pump, the vane chambers are larger in volume due to the design of the cavity. These larger volume vane chambers are filled with fluid forced in by the inlet pressure. Often this inlet pressure is nothing more than atmospheric pressure. On the discharge side of the pump, the vane chambers are smaller in volume, forcing the fluid out of the pump. Rotary vane pumps are used in high and medium pressure applications.

One problem associated with rotary vane pumps or rotary vane pumps is the use of springs or pins for ejecting the vanes outward. The use of springs or pins for biasing vane movement requires lubrication, reduces maximum rotor speed and limits the time between service or maintenance because of the fatigue or failure rate of the pin and spring mechanisms. Also, using pins and springs to bias the vanes outward provides a relatively uncontrolled contact forced between the vanes and the internal surface of the cavity and places a limit on rotor speed.

Accordingly, there is a need for an improved rotary vane pump or pump that requires less lubrication or no lubrication, which is more reliable, which can operate at higher speeds and which has a longer operating life.

### SUMMARY OF THE DISCLOSURE

In satisfaction of the aforenoted needs, an improved rotary vane pump is disclosed which comprises: a rotor disposed within a casing that comprises a cavity having an inlet and an outlet. The rotor includes at least one radial slot and at least one vane carried by the radial slot. The vane comprises an inner edge directed towards a central axis of the rotor and an outer edge directed towards the casing. The inner edge is permanently magnetized with a first polarity. The slot in the rotor comprises an inner wall that abuttingly engages or faces the inner edge of the vane when the vane is fully received within the slot. The inner wall of the slot is permanently magnetized with a second polarity opposite to the first polarity so that the inner edge of the vane and inner wall of the slot repel each other thereby biasing the vane radially outwards.

In a refinement, the inner edge of the vane comprises a first recess that receives a first magnet having first and second poles with the first pole facing the inner wall of the slot, and the inner wall of the slot comprises a second recess that receives a second magnet having first and second poles with the first pole facing the inner edge of the vane.

In a further refinement, the rotor comprises four radial slots, the pump comprises four vanes, each of which are received in one of the slots. Each vane comprises an inner edge directed toward an inner wall of its respective slot, and each inner edge and each inner wall are magnetized with opposite polarities.

Preferably, the inner edge of each vane includes a recess that receives a magnet and the inner wall of each slot includes a recess, aligned with the recess of its respective vane, and which receives a magnet. The magnets of the vanes and rotor recesses are arranged so that like poles of the magnets connected to the vanes face like poles of the magnets connected to the inner walls of the slots of the rotor.

A method for retrofitting a rotor and vane of a rotary vane pump is also disclosed. The method comprises: providing a rotor with at least one slot and a vane received in the slot, the vane comprising an inner edge directed towards a central axis of the rotor and an outer edge directed outwards away from the central axis of the rotor, the slot in the rotor comprising an inner wall that abuttingly engages or faces the inner edge of the vane when the vane is fully received within the slot; connecting the inner edge of the vane to a first magnet; connecting the inner wall of the slot a second magnet; wherein like poles of the first and second magnet are directed toward each other to generate a repelling force that biases the vane away from the inner wall of the slot.

In a refinement, the connecting of the first magnet to the inner edge the vane comprises forming a first recess in the inner edge of the vane and securing the first magnet in the first recess; and the connecting of the second magnet to the inner wall of the slot comprises forming a second recess in the inner wall of the slot and securing the second magnet in the second recess cell that like poles of the first and second magnets face each other.

In another refinement, the retrofitting is carried out on a rotor at that comprises four radial slots, each of which accommodates a vane.

In another refinement, the disclosed magnetic rotary vane pump is incorporated into an air motor.

Other advantages and features will be apparent from the following detailed description when read in conjunction with the attached drawings.

### BRIEF DESCRIPTION OF THE DRAWINGS

One embodiment of a magnetic rotary vane pump made in accordance with this disclosure is illustrated more or less diagrammatically in the following figures, wherein:

FIG. 1 is a perspective view of a pump made in accordance with this disclosure;

FIG. 2 is a sectional view of the pump shown in FIG. 1;

FIG. 3 is an exploded view of the pump shown in FIGS. 1 and 2;

FIG. 4 is a sectional view of the pump casing shown in FIGS. 1-3;

FIG. 5 is a plan view of one of the magnetized vanes shown in FIGS. 2 and 3;

FIG. 6 is an exploded view of the rotor, vanes and magnets shown in FIGS. 2 and 3;

FIG. 7 is an end view of the rotor shown in FIG. 6, particularly illustrating the placement of a magnet along and inside wall of one of the slots that receives one of the vanes; and

FIG. 8 is a partial sectional and exploded view of the rotor, one vane and two magnets associated therewith.

It should be understood that the drawings are not necessarily to scale and that the disclosed embodiments are sometimes illustrated diagrammatically and in partial views. In certain instances, details which are not necessary for an understanding of the disclosed methods and apparatuses or which render other details difficult to perceive may have been omitted. It should be understood, of course, that this disclosure is not limited to the particular embodiments illustrated herein.

### DETAILED DESCRIPTION OF THE PRESENTLY PREFERRED EMBODIMENTS

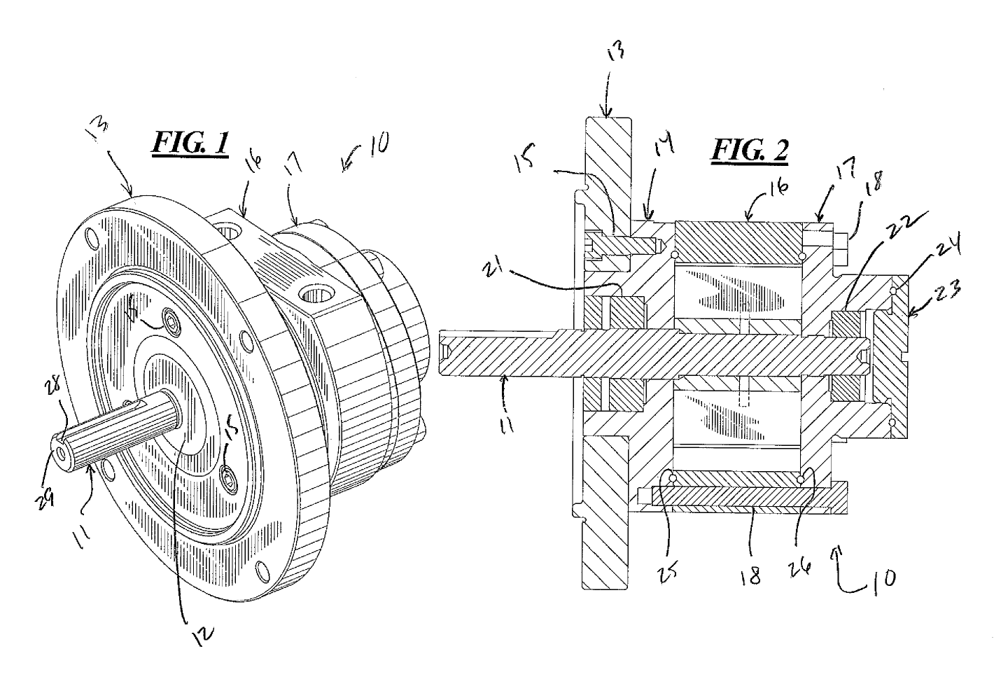

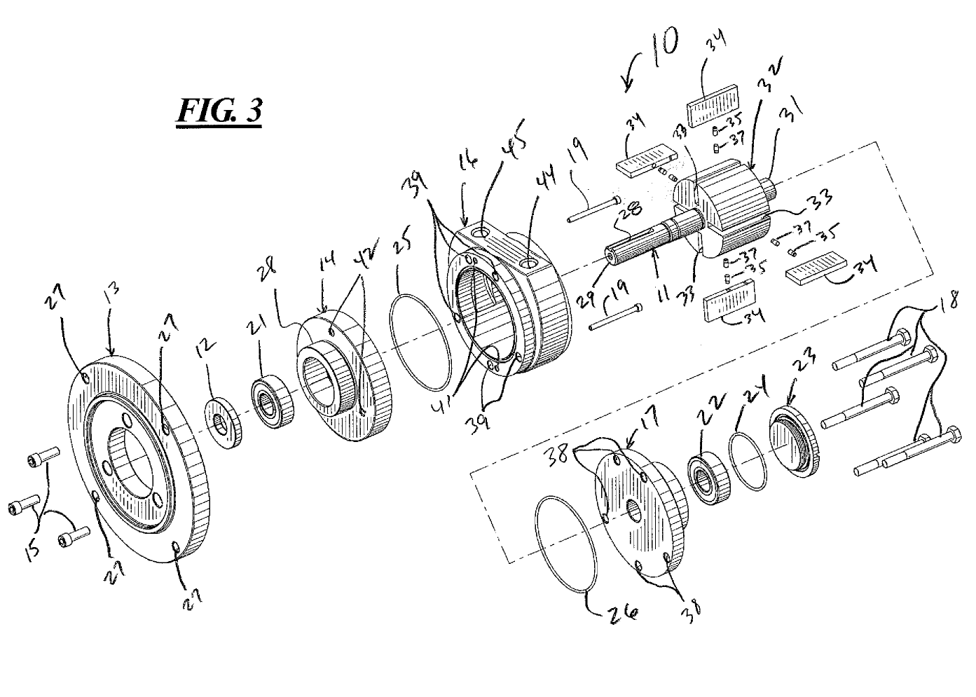

Turning first to FIG. 1, a pump 10 made in accordance with this disclosure is shown in a perspective view. The pump 10 includes a rotor shaft 11 that passes through a seal 12 and mounting bracket 13. The mounting bracket 13 is connected to a front plate 14 by a plurality of fasteners 15 as shown in FIGS. 1-2. A rotor casing 16 is sandwiched between the front plate 14 and a rear plate 17 as best seen in FIG. 2. The rear plate 17, casing 16 and front plate 14 are held together by a plurality of fasteners, two of which are shown at 18 in FIG. 2, while three others are shown in FIG. 3.

As shown in FIG. 3, fasteners 19 may be used to secure the casing 16 to the front plate 14. Referring to FIGS. 1-3, the rotor shaft 11 is supported by a front bearing 21 and a rear bearing 22. An end cap 23 and O-ring seat 24 seals the rear end of the pump 10 while the rotor seal 12 seals the front end of the pump 10. O-rings 25, 26 prevent fluid from leaking between the casing 16 and front and rear plates 14, 17.

As shown in FIG. 3, the mounting bracket 13 may include a plurality of holes or apertures 27 for mounting the pump 10 to a motor housing (not shown). The front plate 14 includes a front hub section 28 for accommodating and supporting that he front bearing 21. The rotor shaft 11 includes a slot 28 at the proximal end 29 of the shaft 11 for attachment to a rotor element of a motor (not shown) while the distal end 31 of the rotor shaft 11 passes through a rotor 32, details of which are illustrated in greater detail in connection with FIG. 6. The rotor 32 shown includes four slots shown at 33, each of which accommodates a vane 34. As described in greater detail below, each vane 34 is attached to a magnet 35 and the inner wall 36 (FIG. 6) of each slot 33 is connected to a magnet 37. Finally, FIG. 3 also shows the apertures 38 that pass through the rear plate 17 and the apertures 39 that pass through the casing 16 that accommodates the fasters 18. FIG. three also illustrates the apertures 41 in the casing 16 that accommodates the fasters 19 that connect the casing 16 to the front plate 14. FIG. 3 also illustrates the apertures 42 that accommodate the fasteners 19.

Turning to FIG. 4, the casing 16 includes input and output ports shown at 44, 45. As the pump 10 is reversible, the ports 44, 45 can serve as either input or output ports, depending upon the rotational direction of the shaft 11 and rotor 32. The casing 16 includes a circular bore 46 for accommodating the rotor 32. The bore 46 is also connected to two recesses or slots 47, 48 for receiving the vanes 34 is the rotor 32 rotates within the casing 16. This disclosure is directed primarily and an improved means for biasing the vanes 34 into the slots 47, 48 as the rotor 30 to rotates.

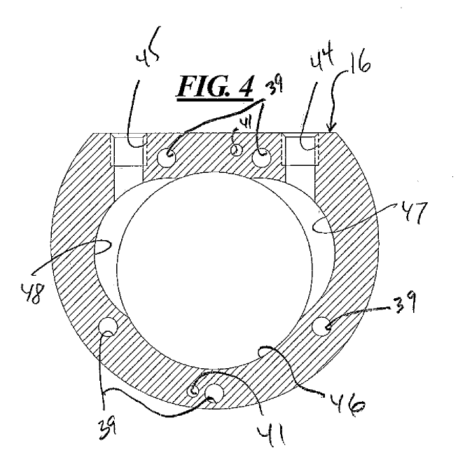

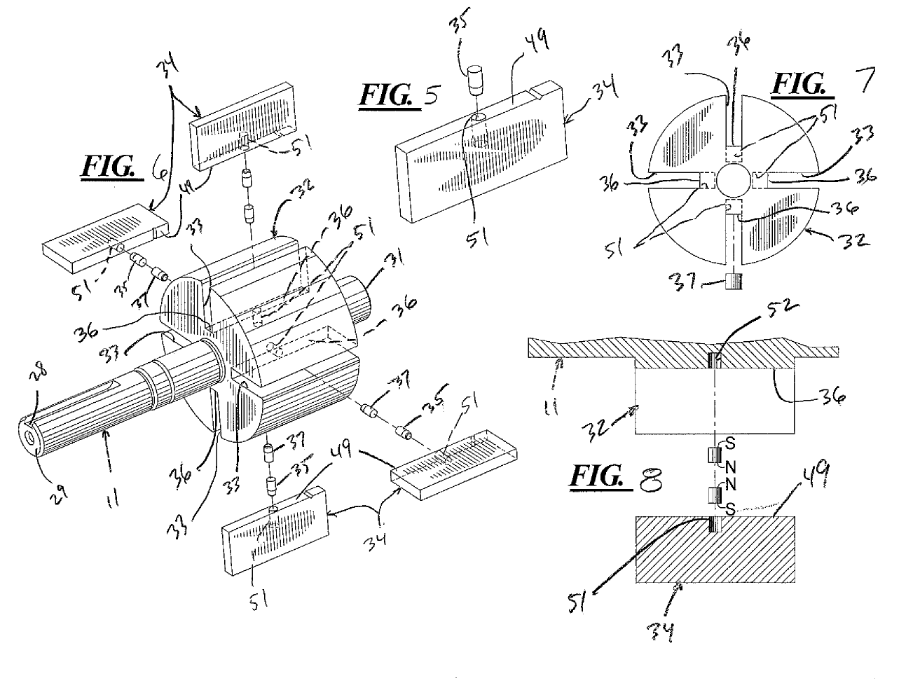

Specifically, FIG. 5 illustrates a vane 34 with an inner edge 49. The inner edge 49 of each vane 34 includes an aperture, slot, hole or recess 51 that accommodates a magnet 35. Similarly, as shown in FIGS. 6-8, the inner wall 36 of each slot 33 includes an aperture, slot, hole or recess 52 that accommodates one of the magnets 37. The magnets 35, 37 are arranged so that like poles are directed towards each other so that the magnets 35, 37 generate a repelling force that biases each vane 34 away from the inner wall 36 and out of its respective slot 33 and into one of the recesses 47, 48 as the rotor 32 rotates within the cavity 46 of the casing 16. The disclosed design does not require a spring or pin or other mechanical feature that requires maintenance or replacement. Further, the disclosed design requires little or no lubrication and can operate at higher speeds than conventional vane pumps.

While only certain embodiments have been set forth, alternatives and modifications will be apparent from the above description to those skilled in the art. These and other alternatives are considered equivalents and within the spirit and scope of this disclosure and the appended claims.

What is claimed is:

1. A rotary vane pump comprising:
a rotor;
a casing comprising a cavity having an inlet and an outlet;
at least one vane carried by a radial slot in the rotor, the vane comprising an inner edge directed towards a central axis of the rotor and an outer edge directed towards the casing, the inner edge being permanently magnetized with a first polarity;
the slot in the rotor comprising an inner wall that abuttingly engages the inner edge of the vane when the vane is fully received within the slot, the inner wall of the slot being permanently magnetized with a second polarity opposite to the first polarity.

2. The pump of claim 1 wherein the inner edge of the vane comprises a first recess that receives a first magnet having first and second poles with the first pole facing the inner wall of the slot, and
the inner wall of the slot comprises a second recess that receives a second magnet having first and second poles with the first pole facing the inner edge of the vane.

3. The pump of claim 1 wherein the rotor comprises four radial slots, the pump comprises four vanes, each of which are received in one of the slots, each vane comprising an inner edge directed toward an inner wall of its respective slot, each inner edge and each inner wall being magnetized with opposite polarities.

4. The pump of claim 1 wherein the rotor comprises four radial slots, the pump comprises four vanes, each of which are received in one of the slots, each vane comprising an inner edge directed toward an inner wall of its respective slot, each inner edge being connected to a magnet, each inner wall being connected to a magnet, wherein like poles of the magnets connected to inner edges of the vanes face like poles of the magnets connected to the inner walls to generate a repelling magnetic forces that bias the vanes away from the inner walls of the slots and towards the casing.

5. A rotary vane pump comprising:
a rotor;
a casing comprising a cavity having an inlet and an outlet;
at least one vane carried by a radial slot in the rotor, the vane comprising an inner edge directed towards a central axis of the rotor and an outer edge directed towards the casing, the inner edge being connected to a first magnet;
the slot in the rotor comprising an inner wall that abuttingly engages the inner edge of the vane when the vane is fully received within the slot, the inner wall of the slot being connected to a second magnet;
wherein like poles of the first and second magnet are directed toward each other to generate a repelling force that biases the vane away from the inner wall of the slot.

6. The pump of claim 5 wherein the inner edge of the vane comprises a first recess that receives the first magnet and
the inner wall of the slot comprises a second recess that receives the second magnet.

7. The pump of claim 5 wherein the rotor comprises four radial slots, the pump comprises four vanes, each of which are received in one of the slots, each vane comprising an inner edge directed toward an inner wall of its respective slot, each inner edge and each inner wall being connected to magnets, wherein like poles of each magnet connected to a vane are directed towards like poles of one of the magnets connected to the inner walls of the slots.

8. An air motor comprising the pump of claim 1.

9. A method for retrofitting a rotor and vane of a rotary vane pump, the method comprising:
providing a rotor with at least one slot a vane received in the slot, the vane comprising an inner edge directed towards a central axis of the rotor and an outer edge directed outwards away from the central axis of the rotor, the slot in the rotor comprising an inner wall that abuttingly engages the inner edge of the vane when the vane is fully received within the slot;
connecting the inner edge of the vane to a first magnet;
connecting the inner wall of the slot a second magnet;
wherein like poles of the first and second magnet are directed toward each other to generate repelling force that biases the vane away from the inner wall of the slot.

10. The method of claim 9 wherein
connecting of the first magnet to the inner edge the vane comprises forming a first recess in the inner edge of the vane and securing the first magnet in the first recess; and
connecting of the second magnet to the inner wall of the slot comprises forming a second recess in the inner wall of the slot and securing the second magnet in the second recess cell that like poles of the first and second magnets face each other.

11. The method of claim 10 wherein the rotor comprises four radial slots, each of which accommodates a vane, and the method comprises retrofitting the inner edge vane with a magnet and each inner wall with a magnet so that like poles of each magnet connected to a vane are directed towards like poles of one of the magnets connected to the inner walls of the slots.

12. The method of claim 9 wherein the pump is incorporated into an air motor.
